(19) United States
(12) Patent Application Publication
(10) Pub. No.: US 2013/0299275 A1
(43) Pub. Date: Nov. 14, 2013

(54) FLEXIBLE, PORTABLE HANDRAIL

(71) Applicants: Karl Heinz Westermann, Round Rock, TX (US); Mary Kay Schittone, Round Rock, TX (US)

(72) Inventors: Karl Heinz Westermann, Round Rock, TX (US); Mary Kay Schittone, Round Rock, TX (US)

(21) Appl. No.: 13/470,388

(22) Filed: May 14, 2012

(51) Int. Cl. A62B 35/00; B65H 75/44; B65H 75/38

(52) U.S. Cl. 182/3; 242/386; 242/382

(57) ABSTRACT

Provided is a manually controlled flexible band play out and slack retracting device including a frame structure and shaft about which a band is wound. A hub may be mounted on the shaft, such that the strap is wound around the hub rather than the shaft, including a radially wound spring secured to the shaft at one and to inner side of the hub at the other end. The band feeds between flat surfaces of a clamping mechanism that includes a hand controlled braking device that applies a squeezing pressure to the band on a dispensing end.

### FIELD OF THE DISCLOSURE

The claimed subject matter relates generally to personal assistance device and, more specifically, to a manually controlled, flexible band that extends and retracts from a reel to provide support for a person when standing, walking and to assist in getting up from a sitting, kneeling or lying down position.

### SUMMARY

Provided is a personal assistance device and, more specifically, to a manually controlled, flexible band that extends and retracts from a reel to provide support for a person when standing, walking and to assist in getting up from a sitting, kneeling or lying down position. As people age, they often experience problems with strength and balance causing some common activities such as walking and rising from a sitting position to become more difficult.

Although there are existing devices that dispense and retract some element, none are suitable for the purposes of the claimed subject matter. Some examples include electrical cord devices, measuring tapes, towing winches, fishing reels and tie down devices, each of which typically dispense and retrieve a wire, string, tape, strap or chain. One example, described in U.S. Pat. No. 5,230,480 to Perry, provides a “flexible member winding in and pay-out device.” However, Perry utilizes a handle crank in which the strap element is fed out through a handle and is therefore not suitable for the purposes of the claimed subject matter. Two additional devices are described in U.S. Pat. Nos. 6,845,736 to Anderson and 4,638,959 to Jones, respectively. Anderson describes a retractable tether for an animal that secures a pet rather than providing support for the user. Jones describes a “pawl controlled reel extension” that is primarily directed at the prevention of spring failure due to over extension of a cable or cord and “bites” into the cable or cord and may lock, jam and snap back upon retraction.

Provided is an apparatus comprising a frame; a belt loop, coupled to the frame, for attaching the frame to a belt; an upper jaw coupled to the frame; a lower jaw positioned between the frame and the upper jaw; a shaft configured to rotate within the frame; a strap attached, at a first end of the shaft, configurable to wrap around the shaft and pass between the upper and lower jaw, the strap comprising a loop at a second end of the shaft opposite the first end; a cam configurable to exert force on the upper jaw, thereby pulling the lower jaw such that the strap is pinched between the upper and lower jaws, thereby restricting movement of the strap with respect to the upper and lower jaws such that the strap provides support to a user.

Another embodiment also comprises a hub configured to rotate around the shaft, wherein the strap is affixed to the outside of the hub rather than the shaft and configurable to wrap around the hub; and a spring mechanism attached, at a first end, to the shaft and, at a second end, to the inside of the hub; wherein the spring mechanism is configured to produce a tension on the strap as the strap is unwound from the hub such that the strap is automatically rewound onto the hub when the movement of the strap is not restricted between the upper and lower jaws.

Advantages of the claimed subject matter over the prior art include, but are not limited to, simplicity, low cost, smooth feed out and retraction, user-controlled feed out and retraction, hand operated, user-controlled braking, user selectable play out distance, light weight, a housing is not required and the element played out does not get tangled.

This summary is not intended as a comprehensive description of the claimed subject matter but rather is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE FIGURES

A better understanding of the claimed subject matter can be obtained when the following detailed description of the disclosed embodiments is considered in conjunction with the following figures.

FIG. 1 is an illustration of various elements of a flexible, personal handrail, or simply “handrail,” in accordance with the claimed subject matter.

FIG. 2 is an illustration of handrail of FIG. 1 with the addition of strap.

FIG. 3 is an illustration of a hub 12, first introduced in conjunction with FIG. 1 with some additional detail.

FIG. 4 is an illustration of a clamping mechanism, first introduced in conjunction with FIG. 1, including additional detail, in an “unclamped” configuration.

FIG. 5 is an illustration of the clamping mechanism of FIGS. 1 and 2 and in a “clamped” configuration.

FIG. 6 is a first illustration of the handrail of FIG. 2 as employed by a user.

FIG. 7 is a second illustration of the handrail of FIG. 2 as employed by a user.

### DETAILED DESCRIPTION OF THE FIGURES

As explained above, as people age common activities such as walking and rising from a sitting position may become more difficult. Provided is a device to assist with these activities that is lightweight, portable, easy to use, inexpensive and ready to use at a moment's notice.

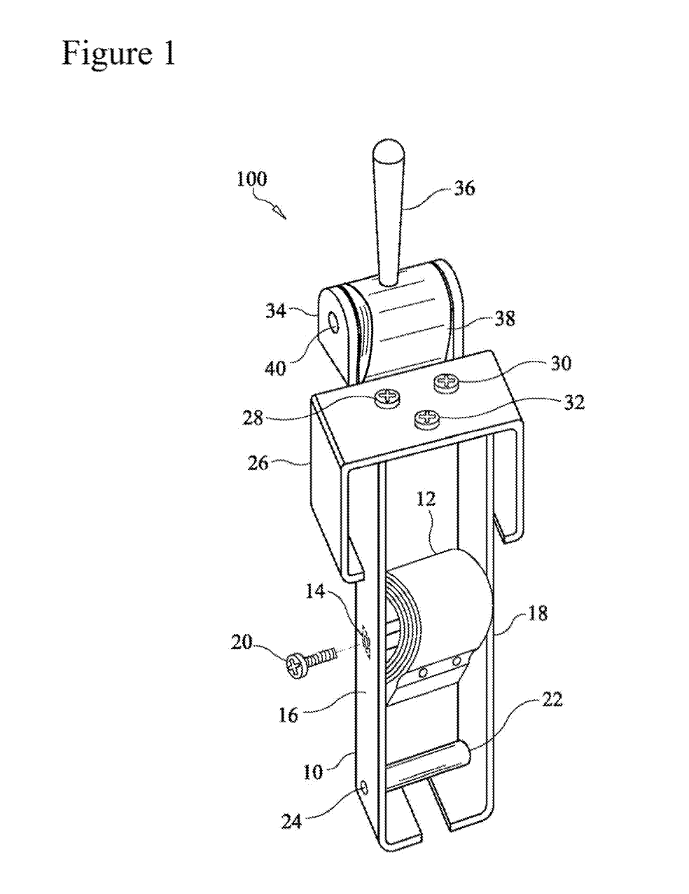

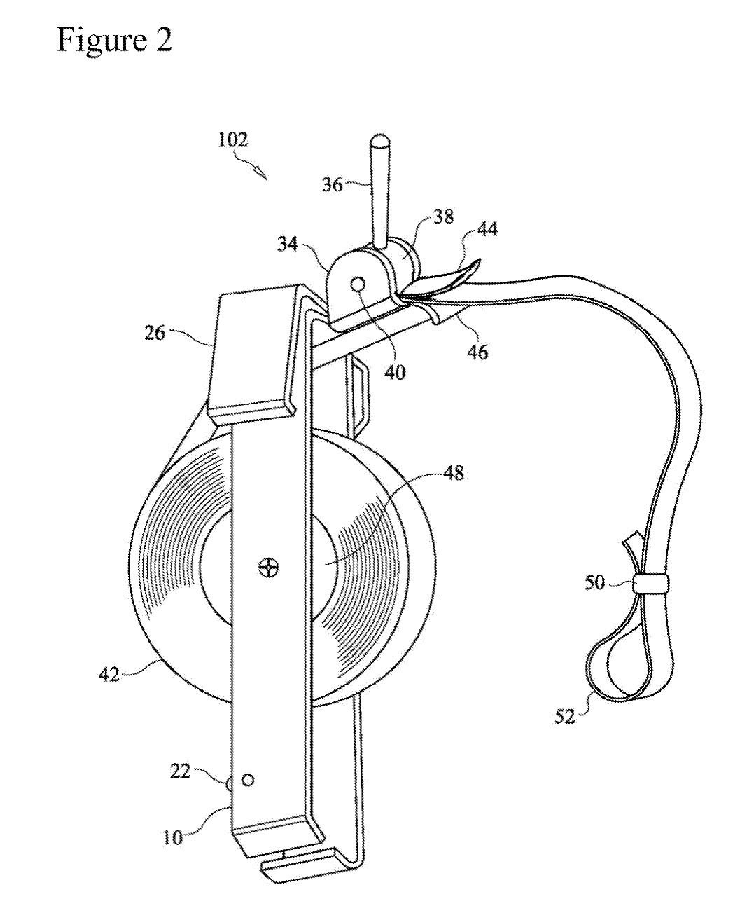

FIG. 1 is an illustration of various elements 100 of a flexible, personal handrail, or simply “handrail,” 102 (see FIG. 2) in accordance with the claimed subject matter. Handrail 100 is similar to a handrail 102 but illustrated without a strap 42 (see FIG. 2) so that various elements are more plainly visible.

A frame 10 supports a hub 12. Hub 12 is affixed to frame 10 by means of a hub shaft 14, which passes through a hole (not shown) in a first side 16 of frame 10, a first hubcap (see 48, FIG. 2), hub 12, a second hubcap (not shown) on a side of hub 12 opposite hubcap 48 and a hole (not shown) in a second side 18 of frame 10. Hub shaft 14 is affixed to frame 10 by means of a pair of fasteners 20 (only one of which is shown), one on each outside surface of sides 16 and 18, respectively, of frame 10. Fasteners 16 may be, but are not limited to, any combination of screws, retainer rings or clips. Hub 12 is configured to rotate around hub shaft 12.

Positioned at a lower end of frame 10 is a roller 22 affixed to frame 10 by means of a pin 24 that passes through frame side 16, roller 22 and frame side 18. It should be noted that frame 10 is partially open at the bottom. This enables a strap 42 (see FIG. 2) to be easily looped or un-looped from around roller 22. A belt clip 26 is affixed to a top end of frame 10 by means of fasteners 28, 30 and 32, which in this example are screws. Fasteners 28, 30 and 32 also affix an upper jaw 46 (see FIGS. 2, 5 and 6) to frame 10.

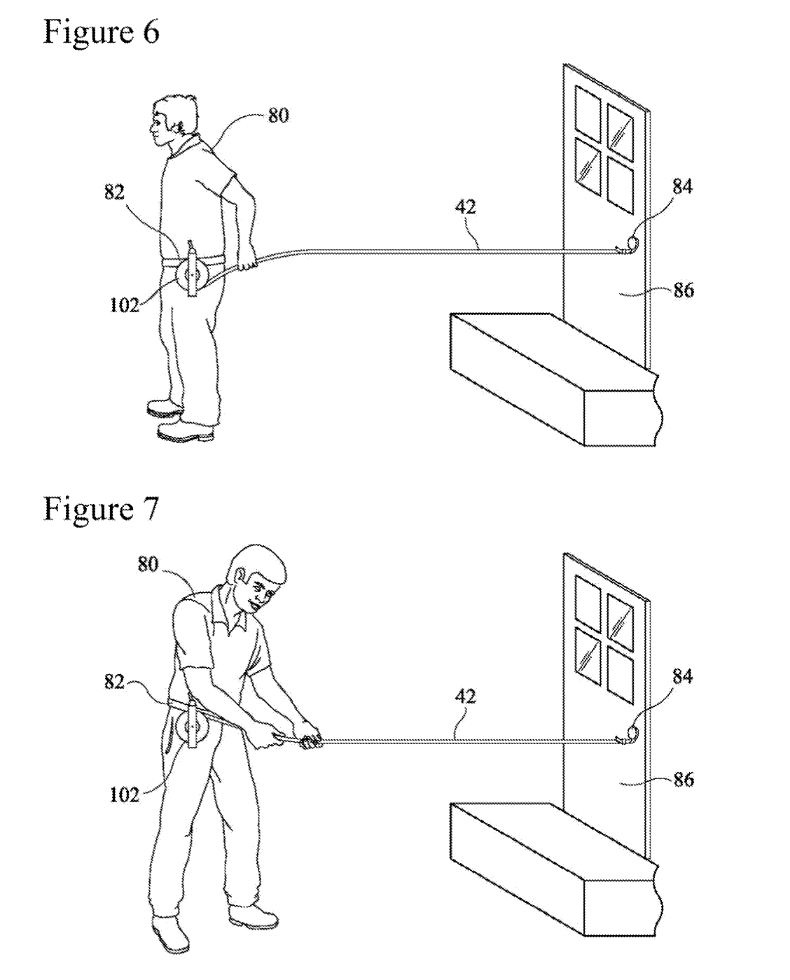

Also affixed to frame 10 is a clamping mechanism 34, which, among other elements, includes a cam handle 36, a cam 38 and a shaft 40. Clamping mechanism 34 and elements 36, 38 and 40 are described in more detail below in conjunction with FIGS. 5 and 6.

FIG. 2 is an illustration of handrail 102, which as explained above in conjunction with FIG. 1, is similar to handrail 100 with the addition of strap 42. Like the illustration of handrail 100 in FIG. 1, the illustration of handrail 102 includes frame 10, roller 22, belt clip 26, clamping mechanism 34, cam handle 36, cam 38 and shaft 40. Also shown is first hubcap 48, which, in conjunction with a second hubcap (not shown) on the opposite of hub 12 (FIG. 1), serves to affix hub 12 to shaft 14 (FIG. 1) and to enable hub 12 to rotate around shaft 14.

Strap, or “band,” 42 may be made of, but is not limited to, rope of the type of material used for automotive seat belts. One example of the material used for strap 42 is polypropylene approximately 0.04 inches thick, 2 inches wide and typically not longer than that which is able to fit onto hub 12 (FIG. 1) within frame 10, which is typical of automotive seatbelts. Strap 42 is wrapped around hub 12, passes between an upper jaw 44 and a lower jaw 46 of clamping mechanism 34, and then may pass under roller 22 (see FIG. 7). At one end of strap 42, a collar 50 enables strap 42 to end in a loop 52. Collar 50 may be positioned with respect to strap 42 to vary the size of loop 52, thereby enabling loop 52 to be placed and secured on various objects (see FIGS. 6 and 7).

Also shown is a first hubcap 48, which, in conjunction with a second hubcap (not shown) on the opposite of hub 12 (FIG. 1), serves to affix hub 12 to shaft 14 (FIG. 1) and to enable hub 12 to rotate around shaft 14.

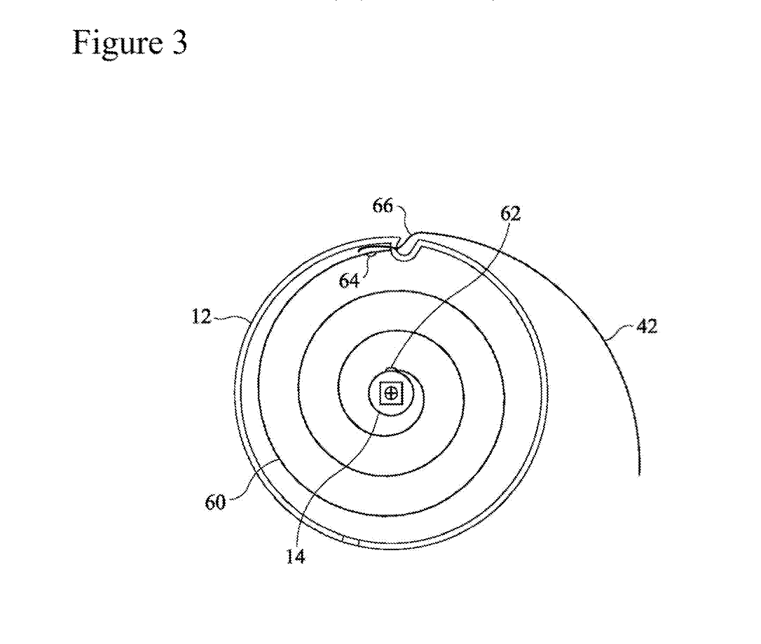

FIG. 3 is an illustration of hub 12, first introduced in conjunction with FIG. 1 with some additional detail. A spring 60, which may also be referred to as a “motor spring” or “clock spring,” is attached to shaft 14 at a point 62 and to the inside of hub 12 at a point 64. When strap 42, which is attached to the outside of hub 12 at a point 66, is pulled from hub 12, tension is created on spring 60 enabling strap 42 to be retracted when strap 42 is released. In other words, spring 60 has minimal tension when strap 42 is wound around hub 12, tension is applied to spring 60 when strap 42 is unwound from hub 12, and the tension enables strap 42 to become rewound on hub 12 when strap 42 is released. Typically, spring 60 is blue temper or stainless steel spring temper and of sufficient dimensions to enable strap 42 to be fully unwound from hub 12 and to be capable of sustaining enough tension to rewind strap 42 onto hub 12.

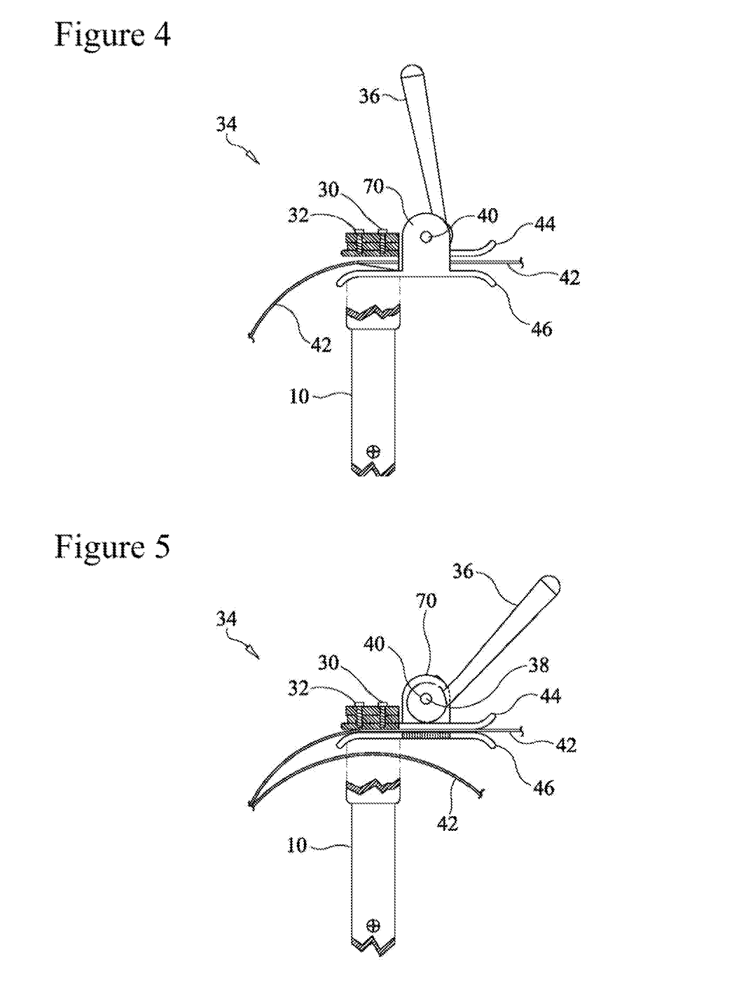

FIG. 4 is an illustration of clamping mechanism 34, first introduced in conjunction with FIG. 1 in an “unclamped” configuration and affixed to frame 10 (FIGS. 1 and 2). As shown in FIGS. 1 and 2, clamping mechanism 34 includes screws 30 and 32, cam handle 36, shaft 40, upper jaw 44 and lower jaw 46. In this figure, cam 38 is obscured by an ear 70 that comes up from one side of lower jaw 46. A second ear (not shown) comes up from the other side of lower jaw 46. Ear 70 and the second ear are formed, i.e. bent up, on each side of lower jaw 46 in a U-shaped manner and provide bearing surfaces for shaft 40. Shaft 40 passes through ear 70, cam 38 and the second ear to enable cam 38 to be rotated around shaft 40. In this example, shaft 40 is a press fit in cam 38 and free to rotate in ear 70 and the second ear.

Strap 42 is wound onto hub 12 (FIG. 1) and positioned between upper jaw 44 and lower jaw 46. In this illustration, strap 42 is not restricted by upper jaw 44 and lower jaw 46 because there is a sufficient gap between jaws 44 and 46 to enable strap 42 to be easily pulled and retracted.

FIG. 5 is an illustration of clamping mechanism 34 of FIGS. 1, 2 and 4 in a “clamped” configuration and affixed to frame 10 (FIGS. 1, 2 and 4). As shown in FIG. 5, clamping mechanism 34 includes cam handle 36, shaft 40, upper jaw 44, lower jaw 46 and ear 70. In this figure, cam 38, which is typically obscured by ear 70, is shown. It should be noted that shaft 40 passes through cam 38 off center. This enables cam 38 to exert pressure on upper jaw 44 when cam handle 36 is rotated around shaft 40, in this example, in a forward direction. Cam 38 may be configured such that cam 38 exerts pressure on upper jaw 44 when earn handle 36 is moved either forward or backward. In an alternative embodiment, cam handle 36 may exert pressure on upper jaw 44 when moved in one direction and, when moved 180° within ear 70 and the second ear, exert pressure when moved in the other direction.

Like in FIG. 5, strap 42 is wound onto hub 12 (FIG. 1) and positioned between upper jaw 44 and lower jaw 46. In this illustration, strap 42 is restricted by upper jaw 44 and lower jaw 46 because there is an insufficient gap between jaws 44 and 46 to enable strap 42 to be easily pulled and retracted. The gap between jaws 44 and 46 may be reduced by moving cam handle 36 such that pressure is exerted on upper jaw 44, thereby pulling lower jaw 46 into a closer proximity to upper jaw 44.

FIG. 6 is a first illustration of handrail 102 of FIG. 2 as employed by a user 80. Handrail 102 is fastened to a belt 82 on user 80 by means of belt clip 26 (FIGS. 1 and 2). In this example loop 52 (FIG. 2) is positioned around a door handle 84 of a door 86 and clamping mechanism 34 is in an unclamped configuration (see FIG. 4) so that user 80 can freely walk away from door 86, within the limits of strap 42. Clamp 50 is positioned such that loop 52 may not easily slide off of door handle 84. Door handle 84 is merely one example of something to which handrail 102 may be attached. Other examples include, but are not limited to, a bed post, a car handle, fence posts, bathroom fixtures and railings. In this example, strap 42 is positioned around roller 22 (see FIG. 1) so that strap 42 may be extended behind user 80.

FIG. 7 is a second illustration of the handrail 102 of FIG. 2 as employed by user 80 (FIG. 6). Like in FIG. 6, loop 52 and clamp 50 are employed to securely attach handrail 102 to door handle 84 of door 86. In this illustration, as opposed to FIG. 6, user 80 has turned around, un-looped strap 42 from around roller 22 and is pulling on strap 42 to facilitate either movement towards door 86 or standing in place. When cam handle 36 is positioned such that strap 42 is in a clamped configuration (see FIG. 4), user 80 may stand in place merely by leaning back against strap 42. In addition, handrail 102 may be used to facilitate rising from a sitting or prone position and to aid in the climbing or descending of stairs.

While the claimed subject matter has been shown and described with reference to particular embodiments thereof, it will be understood by those skilled in the art that the foregoing and other changes in form and detail may be made therein without departing from the spirit and scope of the claimed subject matter, including but not limited to additional, less or modified elements and/or additional, less or modified blocks performed in the same or a different order.

1. An apparatus, comprising:
a frame;
a belt loop, coupled to the frame, for attaching the frame to a belt;
an upper jaw and coupled to the frame;
a lower jaw positioned between the frame and the upper jaw;
a shaft configured to rotate within the frame;
a strap attached, at a first end, to the shaft, configured to wrap around the shaft and pass between the upper and lower jaw, the strap comprising a loop at a second end opposite the first end; and
a cam coupled to the lower jaw and configured to pull the lower jaw towards the upper jaw such that the strap is pinched between the upper and lower jaws, thereby restricting movement of the strap with respect to the upper and lower jaws.

2. The apparatus of claim 1, further comprising:
a hub configured to rotate around the shaft, wherein the strap is affixed to the outside of the hub and configurable to wrap around the huh; and
a radially wound spring mechanism attached, at a first end, to the shaft and, at a second end, to the inside of the hub; wherein the spring mechanism is configured to produce a tension on the strap as the strap is unwound from the hub such that the strap is automatically rewound onto the hub when the movement of the strap is not restricted between the upper and lower jaws.

3. The apparatus of claim 1, further comprising a clasp around the loop configurable to adjust the size of the loop.

4. The apparatus of claim 1, further comprising a belt attached to the frame for securing the apparatus to the user.

5. The apparatus of claim 1, further comprising:
an opening, in the bottom of the frame; and
a roller configured to rotate within the frame and configured to support the strap when the strap is passed through the opening and against the roller so that the strap exits the frame in a direction opposite a direction the strap exits from the upper and lower jaws.

6. The apparatus of claim 1, wherein the cam is configurable to be repositioned 180 degrees with respect to the frame, thereby reversing the direction that the cam is rotated to restrict the movement of the strap with respect to the upper and lower jaws.

7. A personal support device, comprising:
a frame;
a belt loop, coupled to the frame, for attaching the frame to a belt;
an upper jaw and coupled to the frame;
a lower jaw positioned between the frame and the upper jaw;
a shaft configured to rotate within the frame;
a strap attached, at a first end, to the shaft, configured to wrap around the shaft and pass between the upper and lower jaw, the strap comprising a loop at a second end opposite the first end; and
a cam coupled to the lower jaw and configured to pull the lower jaw towards the upper jaw to pinch the strap between the upper and lower jaws, thereby restricting movement of the strap with respect to the upper and lower jaws.

8. The personal support device of claim 7, further comprising:
a hub configured to rotate around the shaft, wherein the strap is affixed to the outside of the hub and configurable to wrap around the hub; and
a radially wound spring mechanism attached, at a first end, to the shaft and, at a second end, to the inside of the hub; wherein the spring mechanism is configured to produce a tension on the strap as the strap is unwound from the huh such that the strap is automatically rewound onto the hub when the movement of the strap is not restricted between the upper and lower jaws.

9. The personal support device of claim 7, further comprising a clasp around the loop configurable to adjust the size of the loop.

10. The personal support device of claim 7, further comprising a belt attached to the frame for securing the apparatus to the user.

11. The personal support device of claim 7, further comprising:
an opening in the bottom of the frame; and
a roller configured to rotate within the frame and configured to support the strap when the strap is passed through the opening and against the roller so that the strap exits the frame in a direction opposite a direction the strap exits from the upper and lower jaws.

12. The personal support device of claim 7, wherein the cam is configurable to be repositioned 180 degrees with respect to the frame to reverse the direction which the cam is rotated to restrict the movement of the strap with respect to the upper and lower jaws.

13. A portable handrail, comprising:
a frame;
a belt loop, coupled to the frame, for attaching the frame to a belt;
an upper jaw and coupled to the frame;
a lower jaw positioned between the frame and the upper jaw;
a shaft configured to rotate within the frame;
a strap attached, at a first end, to the shall, configured to wrap around the shaft and pass between the upper and lower jaw, the strap comprising a loop at a second end opposite the first end; and
a cam coupled to the lower jaw and configured to pull the lower jaw towards the upper jaw such that the strap is pinched between the upper and lower jaws, thereby restricting movement of the strap with respect to the upper and lower jaws.

14. The portable handrail of claim 13, further comprising:
a hub configured to rotate around the shaft, wherein the strap is affixed to the outside of the hub and configurable to wrap around the hub; and
as radially wound spring mechanism attached, at a first end, to the shaft and, at a second end, to the inside of the hub; wherein the spring mechanism is configured to produce a tension on the strap as the strap is unwound from the huh such that the strap is automatically rewound onto the hub when the movement of the strap is not restricted between the upper and lower jaws.

15. The portable handrail of claim 13, further comprising a clasp around the loop configurable to adjust the size of the loop.

16. The portable handrail of claim 13, further comprising a belt attached to the frame for securing the apparatus to the user.

17. The portable handrail of claim 13, further comprising:
an opening in the bottom of the frame; and
a roller configured to rotate within the frame and configured to support the strap when the strap is passed through the opening and against the roller so that the strap exits the frame in a direction opposite a direction the strap exits from the upper and lower jaws.

18. The portable handrail of claim 13, wherein the cam is configurable to be repositioned 180 degrees with respect to the frame, thereby reversing the direction that the cam is rotated to restrict the movement of the strap with respect to the upper and lower jaws.
